(19) United States
(12) Patent Application Publication
(10) Pub. No.: US 2026/0017804 A1
(43) Pub. Date: Jan. 15, 2026

(54) OBJECT TRACKING METHOD AND SURVEILLANCE APPARATUS

(71) Applicant: Vivotek Inc., New Taipei City (TW)

(72) Inventors: Cheng-Chieh Liu, New Taipei City (TW); Fu-Min Wang, New Taipei City (TW)

(73) Assignee: Vivotek Inc., New Taipei City (TW)

(21) Appl. No.: 19/260,636

(22) Filed: Jul. 7, 2025

(30) Foreign Application Priority Data
Jul. 11, 2024 (TW) 113126010

(51) Int. Cl. G06T 7/246; G06V 10/764

(52) U.S. Cl. CPC G06T 7/246; G06V 10/764; G06T 2207/10016; G06T 2207/20021; G06T 2207/20081

(57) ABSTRACT

An object tracking method is applied to a surveillance apparatus and includes acquiring a first image, a second image and a third image in sequence, at least detecting a first object in the first image and at least detecting a second object in the second image, deciding the first object and the second object are relative and then classify a static object or a dynamic object, at least detecting a current object in the third image, utilizing a low loading tracking algorithm to compare the static object with the current object, and deciding whether the current object is suitable for the low loading tracking algorithm according to a comparison result.

### BACKGROUND OF THE INVENTION

### 1. Field of the Invention

The present invention relates to an object tracking method and a surveillance apparatus, and more particularly, to an object tracking method and a related surveillance apparatus with preferred computation efficiency and preferred tracking accuracy.

### 2. Description of the Prior Art

A conventional object tracking method sets the background model based on pixel values, and find object position in the image according to pixel changes in multiple images. However, the conventional object tracking method only finds the object position in the image, and cannot recognize the type of the object (e.g., person or car) or the form of the object (e.g., static or dynamic); other object recognition technology must be used to analyze the image for acquiring detailed information of the object. The object tracking method based on artificial intelligence detects and analyzes the single image to find the information of the object. The object tracking method based on the background model or the artificial intelligence cannot provide preferred computation efficiency and accuracy in object matching and tracking process. Therefore, design of an object tracking method capable of providing preferred computation efficiency and accuracy is an important issue in the related surveillance apparatus industry.

### SUMMARY OF THE INVENTION

The present invention provides an object tracking method and a related surveillance apparatus with preferred computation efficiency and preferred tracking accuracy for solving above drawbacks.

According to one embodiment, an object tracking method is applied to a surveillance apparatus having an operation processor and an image receiver. The object tracking method includes acquiring a first image, a second image and a third image in sequence from the image receiver, at least detecting a first object in the first image and at least detecting a second object in the second image, deciding the first object and the second object are relative and then classifying under a static object or a dynamic object, at least detecting a current object in the third image, utilizing a low loading tracking algorithm to compare the static object with the current object, and deciding whether the current object is suitable for the low loading tracking algorithm or a high loading tracking algorithm in accordance with a comparison result of the static object and the current object.

According to another embodiment, a surveillance apparatus includes an image receiver and an operation processor. The image receiver is adapted to acquire a first image, a second image and a third image in sequence. The operation processor is electrically connected with the image receiver, and adapted to at least detect a first object in the first image and at least a second object in the second image, decide the first object and the second object are relative and then classify under a static object or a dynamic object, at least detect a current object in the third image, utilize a low loading tracking algorithm to compare the static object with the current object, and decide whether the current object is suitable for the low loading tracking algorithm or a high loading tracking algorithm in accordance with a comparison result of the static object and the current object.

The object tracking method and the surveillance apparatus of the present invention can mark the bounding box for the target object in the temporally or spatially continuous images, and compute the overlay ratio of the bounding boxes between different images to decide whether to continuously track the target object using the low loading tracking algorithm or the high loading tracking algorithm. The object tracking process can be continued in plural images, where the loading type of the specific object tracking algorithm may be switched due to overlay change of the bounding boxes. If the plural images are analyzed to track the target object using the specific object tracking algorithm in the same loading type, the target object can be classified under the static object or the dynamic object in accordance with the overlay ratio of the bounding boxes in the images, thereby performing related image content analysis to acquire characteristic parameters of the static object or the dynamic object for further application.

In the conventional technology, when the dynamic object is moved to pass by and be blocked by the static object, the dynamic object can be considered a new object when the dynamic object is appeared in the image again, causing a mistake in the object matching and tracking process. The object tracking method and the related surveillance apparatus of the present invention can perform the object recognition process to find the object that meets the preset type, and classify the object that meets the preset type for deciding the loading type of the object tracking algorithm. Then, the present invention can determine whether the current object in the following image matches to the static object in the previous image, and find out the static object and then track the dynamic object. Therefore, the present invention can determine that after the dynamic object passes by and is blocked by the static object, the dynamic object can be regarded as the same object when it is appeared in the image again, thereby effectively improving the accuracy of the object tracking and recognition process, and reducing system operation amount of the surveillance apparatus for preferred computation efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a surveillance apparatus according to an embodiment of the present invention.

FIG. 2 is a flow chart of an object tracking method according to the embodiment of the present invention.

FIG. 3 to FIG. 5 are diagrams of images acquired by the surveillance apparatus in object recognition, object classification and object tracking process according to the embodiment of the present invention.

### DETAILED DESCRIPTION

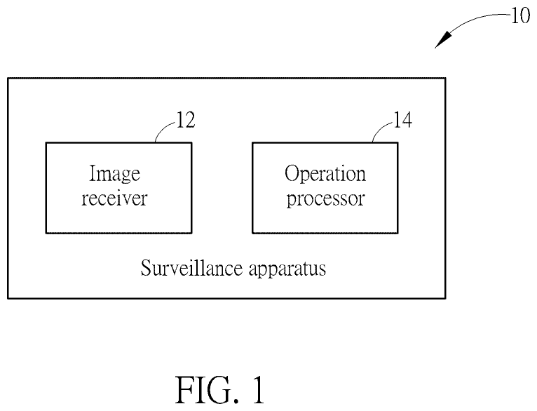

Please refer to FIG. 1. FIG. 1 is a functional block diagram of a surveillance apparatus 10 according to an embodiment of the present invention. The surveillance apparatus 10 can include an image receiver 12 and an operation processor 14 electrically connected with each other. The image receiver 12 can acquire a video containing a plurality of images. The image receiver 12 can directly capture a surveillance video about a surveillance area of the surveillance apparatus 10, or can receive the surveillance video about the surveillance area of the surveillance apparatus 10 captured by an external camera. The operation processor 14 can execute an object tracking method of the present invention. The object tracking method can identify an object that meets a preset style (such as a vehicle) from the surveillance image, and classify the object that meets the preset style by an object type (such as classifying under a static object and/or a dynamic object), and perform a specific object tracking algorithm with different loading types depending on the object type, thereby allowing subsequent image content analysis.

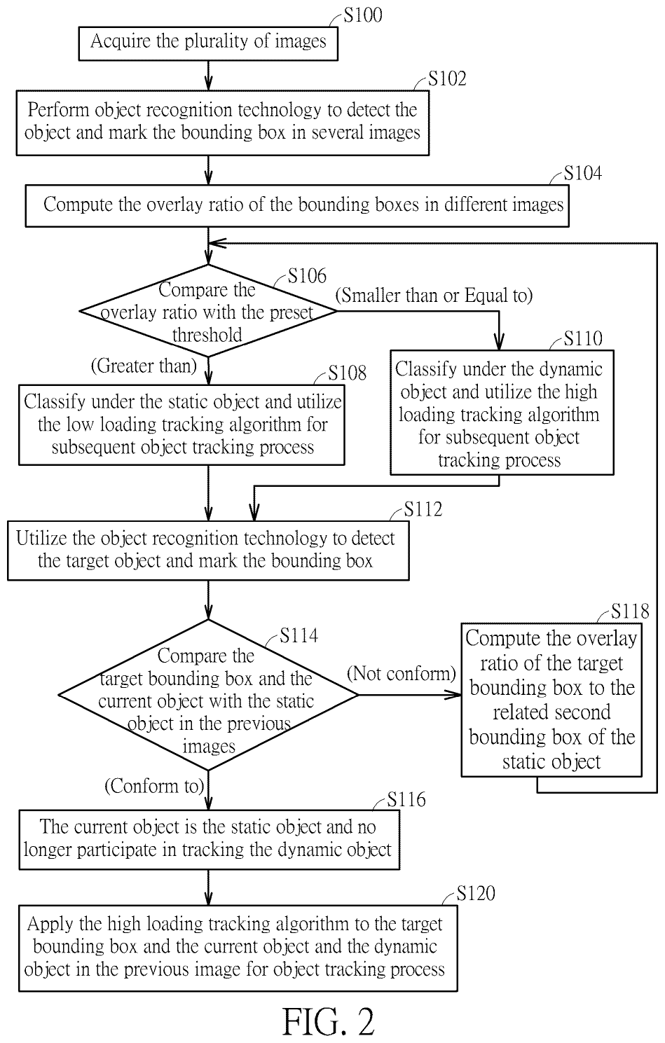

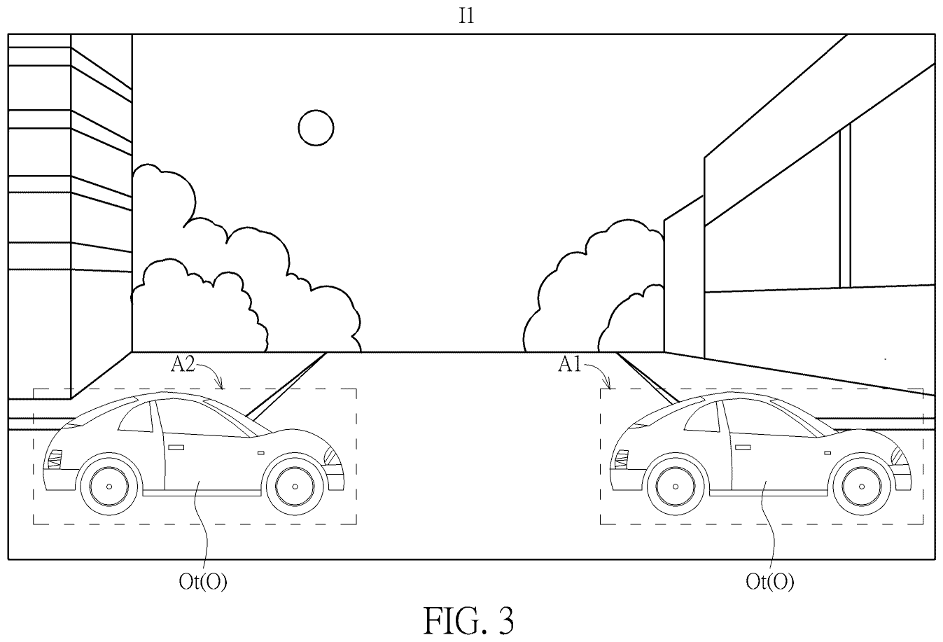

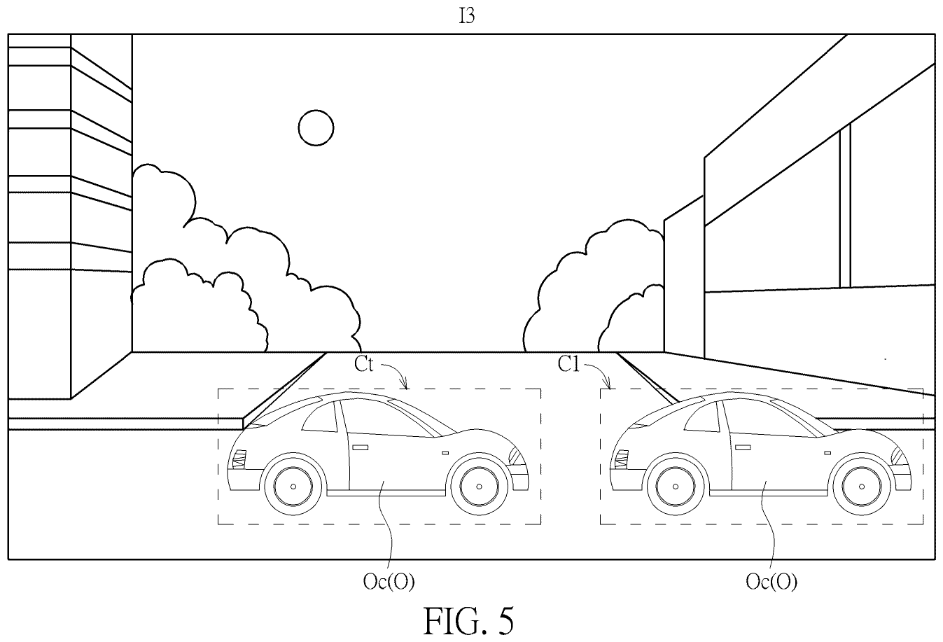

Please refer to FIG. 2 to FIG. 5. FIG. 2 is a flow chart of an object tracking method according to the embodiment of the present invention. FIG. 3 to FIG. 5 are diagrams of images acquired by the surveillance apparatus 10 in object recognition, object classification and object tracking process according to the embodiment of the present invention. Regarding the object tracking method, step S100 and step S102 can be executed to sequentially acquire a plurality of images by the image receiver 12, and perform object recognition technology to detect an object O and accordingly mark bounding boxes respectively in images temporally or spatially closed to each other. The foresaid images can be exemplified by a first image I1, a second image I2 and a third image I3 generated in temporally or spatially sequence. A generation point of time of the second image I2 can be later than a generation point of time of the first image I1. A generation point of time of the third image I3 can be later than the generation point of time of the second image I2. Wherein, the images I1, I2, and I3 can be generated at equal time intervals, or at different time intervals if the images are temporally closed to each other. In one embodiment, the images I1, I2 and I3 can be generated and cause the object recognition to be trigger in temporal order. In another embodiment, the image I2 may be the first image which causes the object recognition to be triggered in temporal order.

The object recognition technology can be a deep learning model such as a convolutional neural network, or any recognition model with sufficient recognition accuracy. The object recognition technology can find the object O that meets the preset style in the images for marking the bounding box in accordance with the preset object style. For example, the object recognition technology can find the vehicle and mark the bounding box in the image, excluding the object belonging to people; or, the object recognition technology can find the small car and mark the bounding box in the image, excluding the object belonging to the large car. Application of the object recognition technology is not limited to the foresaid embodiments. Any technology that can find the object O that meets the preset object style can conform to the design requirement of the present invention.

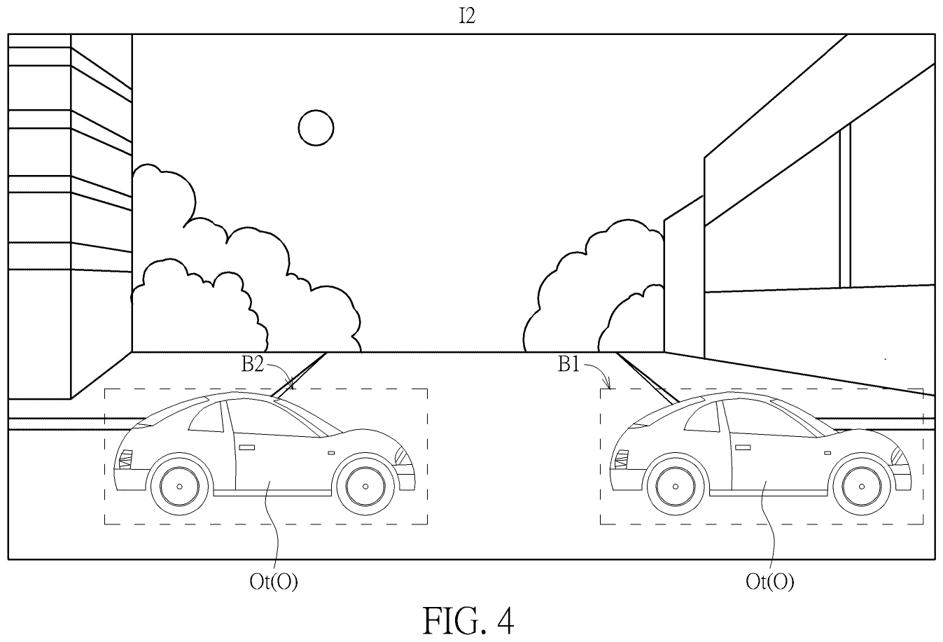

In the embodiment of the present invention, the object tracking method can detect the first object (such as a target object Ot) and accordingly mark first bounding boxes A1 and A2 in the first image I1, and further can detect the second object (such as the target object Ot) and accordingly mark second bounding boxes B1 and B2 in the second image I2. A number and position of the bounding box can depend on an actual situation. As the embodiment shown in FIG. 3 and FIG. 4, the target object Ot marked by the first bounding boxes A1 and A2 and the second bounding boxes B1 and B2 can be the vehicle, but actual application is not limited thereto, and can depend on a recognition parameter of the object recognition technology performed by step S102.

Then, step S104 can be executed to compute several overlay ratios of all the first bounding boxes A1 and A2 respectively to all the second bounding boxes B1 and B2. As shown in FIG. 3 and FIG. 4, the object tracking method can compute the overlay ratios of the first bounding box A1 respectively to the second bounding boxes B1 and B2, and select an overlay ratio that meets a condition from multiple overlay ratios R1 and R2 in accordance with a preset condition, and then determine the bounding box corresponding to the selected overlay ratio can cover the same target object Ot. For example, the preset condition can be designed as a specific overlay area, or a distance between specific centers of two bounding boxes for being a threshold. The object tracking method can compute the overlay ratio R1 of the first bounding box A1 to the second bounding box B1, and the overlay ratio R2 of the first bounding box A1 to the second bounding box B2. Then, the object tracking method can determine the overlay ratio R1 conforms to the preset condition, and the first bounding box A1 and the second bounding box B1 that correspond to the overlay ratio R1 can mark the same target object Ot, thereby the overlay ratio R1 belonging to the foresaid selected overlay ratio.

Accordingly, step S104 can further compute the multiple overlay ratios of the first bounding box A2 respectively to the second bounding boxes B1 and B2, so as to determine whether the first bounding box A2 is matched with the second bounding box B1 or the second bounding box B2, and to ensure the first bounding box A2 and the second bounding box B2 that have the overlay ratio conforms to the preset condition can mark the same target object Ot. If the first image I1 still contains the first bounding box (which is not shown in the figures) other than the first bounding boxes A1 and A2, the above steps can be executed to find the second bounding box (which is not shown in the figures) matched with the foresaid first bounding box in the second image I2; a detailed description is omitted herein for simplicity.

After confirming matching results of the bounding box in different images (step S104), step S106 can be executed to compare the multiple overlay ratios respectively with the preset threshold for classification of object type based on a comparison result of the overlay ratio. The preset threshold can be designed as a parameter relevant to intersection over union (IOU), but actual application is not limited thereto. As mentioned above, when the overlay ratio is greater than the preset threshold (e.g., the overlay ratio R1 of the first bounding box A1 to the second bounding box B1 exceeds the preset threshold), an overlay area of the first bounding box A1 and the second bounding box B1 is large, and the target object Ot marked by the first bounding box A1 and the second bounding box B1 can be static or slightly moved during a time period between the first image I1 and the second image I2, so that step S108 can be executed to classify it under the static object, and utilize the low loading tracking algorithm to perform the subsequent object tracking process.

When the overlay ratio is smaller than or equal to the preset threshold (e.g., the overlay ratio R1 of the first bounding box A1 to the second bounding box B1 is smaller than the preset threshold), the overlay area of the first bounding box A1 and the second bounding box B1 is small, and the target object Ot marked by the first bounding box A1 and the second bounding box B1 can be moved over a large range during the time period between the first image I1 and the second image I2, so that step S110 can be executed to classify it under the dynamic object, and utilize the high loading tracking algorithm to perform the subsequent object tracking process. Therefore, step S108 and step S110 can classify the target object Ot under the static object or the dynamic object in accordance with the overlay ratio of the corresponding bounding boxes in different images, thereby deciding whether to track the target object Ot using the low loading tracking algorithm or the high loading tracking algorithm in the subsequent images.

Then, step S112 and step S114 can be executed to utilize the object recognition technology to detect a current object Oc and accordingly mark one or some bounding boxes (such as a third bounding box Cl and a target bounding box Ct) in the third image I3 in accordance with the preset object style, and compare the bounding box in the third image I3 with the target object Ot which is classified under the static object by step S108. In step S112, the object recognition technology can find the current object Oc that has the same type as the target object Ot in the first image I1 and the second image I2 in accordance with the preset object style from the third image I3, and mark the related bounding box. The present invention uses the target bounding box Ct as an example for explanation, but the actual application is not limited thereto. In step S114, the object tracking method can utilize the low loading tracking algorithm to compare the static object (such as the target object Ot and the related second bounding box B1) in the second image I2 with the current object Oc; after eliminating possibility of the static object, the object tracking method can utilize the high loading tracking algorithm to compare the dynamic object (such as the target object Ot and the related second bounding box B2) in the second image I2 with the current object Oc, thereby effectively increasing computation performance of the surveillance apparatus 10.

If a comparison result of step S114 indicates that the current object Oc conforms to the static object in the second image I2, step S116 can be executed to ensure the current object Oc belongs to the static object and apply the low loading tracking algorithm for the object tracking process, and exclude it from dynamic object tracking. If the comparison result of step S114 indicates that the current object Oc does not conform to the static object in the second image I2, step S118 can be executed to compute the overlay ratio of the target bounding box Ct to the related second bounding box B2; then, step S106, step S108 and step S110 can be executed again to compare the overlay ratio computed by step S118 with the preset threshold, determine whether the current object Oc belongs to the static object or the dynamic object, and choose the low loading tracking algorithm or the high loading tracking algorithm for the subsequent object tracking process.

When the static object is processed by step S114, step S116 and step S118, step S120 can be executed by the object tracking method to compare the target object Ot that is classified under the dynamic object in the second image I2 with the dynamic object (e.g., the current object Oc or the related target bounding box Ct that does not belong to the static object) in the third images I3 for the object tracking process performed by the high loading tracking algorithm. According to the foresaid object tracking method, the present invention can effectively improve accuracy of the object tracking and recognition process. For example, when the dynamic object (such as a moving object) and the static object (such as a stationary object) are overlaid and then separated in the image due to a capturing angle of the camera, conventional technology cannot correctly determine that the dynamic object that is not overlaid (or before the overlay) can be the same as the dynamic object that is overlaid and then separated from the static object, resulting in a drawback that two dynamic objects mentioned as above cannot be correctly recognized as the same object and cannot be tracked continuously. However, the object tracking method of the present invention can effectively avoid the drawback through the foresaid step S114, step S116 and step S118.

In conclusion, the object tracking method and the surveillance apparatus of the present invention can mark the bounding box for the target object in the temporally or spatially continuous images, and compute the overlay ratio of the bounding boxes between different images to decide whether to continuously track the target object using the low loading tracking algorithm or the high loading tracking algorithm. The object tracking process can be continued in plural images, where the loading type of the specific object tracking algorithm may be switched due to overlay change of the bounding boxes. If the plural images are analyzed to track the target object using the specific object tracking algorithm in the same loading type, the target object can be classified under the static object or the dynamic object in accordance with the overlay ratio of the bounding boxes in the images, thereby performing related image content analysis to acquire characteristic parameters of the static object or the dynamic object for further application.

In the conventional technology, when the dynamic object is moved to pass by and be blocked by the static object, the dynamic object can be considered a new object when the dynamic object is appeared in the image again, causing a mistake in the object matching and tracking process. The object tracking method and the related surveillance apparatus of the present invention can perform the object recognition process to find the object that meets the preset type, and classify the object that meets the preset type for deciding the loading type of the object tracking algorithm. Then, the present invention can determine whether the current object in the following image matches to the static object in the previous image, and find out the static object and then track the dynamic object. Therefore, the present invention can determine that after the dynamic object passes by and is blocked by the static object, the dynamic object can be regarded as the same object when it is appeared in the image again, thereby effectively improving the accuracy of the object tracking and recognition process, and reducing system operation amount of the surveillance apparatus for preferred computation efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An object tracking method applied to a surveillance apparatus having an operation processor and an image receiver, the object tracking method comprising:
the operation processor acquiring a first image, a second image and a third image in sequence from the image receiver;
the operation processor at least detecting a first object in the first image and at least detecting a second object in the second image;
the operation processor deciding the first object and the second object are relative and then classifying under a static object or a dynamic object;
the operation processor at least detecting a current object in the third image;
the operation processor utilizing a low loading tracking algorithm to compare the static object with the current object; and
the operation processor deciding whether the current object is suitable for the low loading tracking algorithm or a high loading tracking algorithm in accordance with a comparison result of the static object and the current object.

2. The object tracking method of claim 1, further comprising:
the operation processor utilizing object recognition technology to generate a first bounding box for the first object in the first image, to generate a second bounding box for the second object in the second image, and to generate a target bounding box for the current object in the third image.

3. The object tracking method of claim 1, further comprising:
the operation processor generating a first bounding box for the first object in the first image, generating a second bounding box for the second object in the second image, and generating a target bounding box for the current object in the third image;
the operation processor computing an overlay ratio of the first bounding box to the related second bounding box; and
the operation processor comparing the overlay ratio with a preset threshold for classification of the static object or the dynamic object.

4. The object tracking method of claim 3, further comprising:
the operation processor determining a target object corresponding to the overlay ratio being classified under the static object when the overlay ratio is greater than the preset threshold.

5. The object tracking method of claim 3, further comprising:
the operation processor determining a target object corresponding to the overlay ratio being classified under the dynamic object when the overlay ratio is smaller than or equal to the preset threshold.

6. The object tracking method of claim 1, further comprising:
the operation processor generating a target bounding box for the current object in the third image; and
the operation processor utilizing object recognition technology to mark the target bounding box in the third image in accordance with a preset object style.

7. The object tracking method of claim 1, further comprising:
the operation processor utilizing the low loading tracking algorithm to perform object tracking process on the static object when the comparison result indicates the current object conforms to the static object.

8. The object tracking method of claim 1, further comprising:
the operation processor generating a second bounding box for the second object in the second image and generating a target bounding box for the current object in the third image;
the operation processor computing an overlay ratio of the target bounding box to the second bounding box when the comparison result indicates the current object does not conform to the static object; and
the operation processor comparing the overlay ratio with a preset threshold for classification of the static object or the dynamic object.

9. The object tracking method of claim 1, further comprising:
the operation processor determining at least one dynamic object and at least one static object in accordance with the first image and the second image; and
the operation processor utilizing the high loading tracking algorithm to compare the dynamic object with another current object when the static object is compared with the current object.

10. A surveillance apparatus comprising:
an image receiver adapted to acquire a first image, a second image and a third image in sequence; and
an operation processor electrically connected with the image receiver, and adapted to at least detect a first object in the first image and at least a second object in the second image, decide the first object and the second object are relative and then classify under a static object or a dynamic object, at least detect a current object in the third image, utilize a low loading tracking algorithm to compare the static object with the current object, and decide whether the current object is suitable for the low loading tracking algorithm or a high loading tracking algorithm in accordance with a comparison result of the static object and the current object.

11. The surveillance apparatus of claim 10, wherein the operation processor is adapted to further utilize object recognition technology to generate a first bounding box for the first object in the first image, to generate a second bounding box for the second object in the second image, and to generate a target bounding box for the current object in the third image.

12. The surveillance apparatus of claim 10, wherein the operation processor is adapted to further generate a first bounding box for the first object in the first image and generate a second bounding box for the second object in the second image and generate a target bounding box for the current object in the third image, compute an overlay ratio of the first bounding box to the related second bounding box, and compare the overlay ratio with a preset threshold for classification of the static object or the dynamic object.

13. The surveillance apparatus of claim 12, wherein the operation processor is adapted to further determine a target object corresponding to the overlay ratio being classified under the static object when the overlay ratio is greater than the preset threshold.

14. The surveillance apparatus of claim 12, wherein the operation processor is adapted to further determine a target object corresponding to the overlay ratio being classified under the dynamic object when the overlay ratio is smaller than or equal to the preset threshold.

15. The surveillance apparatus of claim 10, wherein the operation processor is adapted to further generate a target bounding box for the current object in the third image, and utilize object recognition technology to mark the target bounding box in the third image in accordance with a preset object style.

16. The surveillance apparatus of claim 10, wherein the operation processor is adapted to further utilize the low loading tracking algorithm to perform object tracking process on the static object when the comparison result indicates the current object conforms to the static object.

17. The surveillance apparatus of claim 10, wherein the operation processor is adapted to further generate a second bounding box for the second object in the second image and generate a target bounding box for the current object in the third image, compute an overlay ratio of the target bounding box to the second bounding box when the comparison result indicates the current object does not conform to the static object, and compare the overlay ratio with a preset threshold for classification of the static object or the dynamic object.

18. The surveillance apparatus of claim 10, wherein the operation processor is adapted to further determine at least one dynamic object and at least one static object in accordance with the first image and the second image, and utilize the high loading tracking algorithm to compare the dynamic object with another current object when the static object is compared with the current object.
